(19) United States
(12) Patent Application Publication
(10) Pub. No.: US 2026/0219506 A1
(43) Pub. Date: Jul. 30, 2026

(54) IMAGE PROCESSING SYSTEM, IMAGE PROCESSING METHOD, AND PROGRAM

(71) Applicant: Sony Interactive Entertainment Inc., Tokyo (JP)

(72) Inventors: Jun Horie, Tokyo (JP); Yasutoshi Katsuda, Tokyo (JP); Shotaro Tada, Tokyo (JP)

(21) Appl. No.: 19/571,893

(22) Filed: Mar. 19, 2026

Related U.S. Application Data
(63) Continuation of application No. PCT/JP2023/034050, filed on Sep. 20, 2023.

(51) Int. Cl. G02B 27/01; G06T 5/80

(52) U.S. Cl. CPC G02B 27/0172; G06T 5/80

(57) ABSTRACT

Provided is an image processing system for generating a display image that is displayed on a display panel provided on a head-mounted display attached to the head of a user and that is enlarged, by a lens unit provided in correspondence with the display panel, to be visually recognized. The image processing system includes an inclination correction section that corrects image data input to the display panel, on the basis of an inclination correction value associated with the display image in a three-dimensional space, and an image generation section that generates the display image according to the image data corrected on the basis of the inclination correction value.

### CROSS-REFERENCES TO RELATED APPLICATIONS

This application is a continuation application of International Patent Application No. PCT/JP 2023/034050, filed on Sep. 20, 2023, the entire disclosure of which is incorporated herein by reference for all purposes.

### TECHNICAL FIELD

The present disclosure relates to an image processing system, an image processing method, and a program.

### BACKGROUND

Head-mounted displays (HMDs) equipped with a display panel for displaying images have conventionally been known. Such a head-mounted display is described in, for example, PCT Patent Publication No. WO2016/136657.

### SUMMARY

A configuration which includes a lens unit corresponding to a display panel, in addition to an ocular lens, to improve resolution of display images has been sought. In the configuration which enables the display panel to achieve enlarged display with use of the lens unit as noted above, sufficient positional accuracy of the display panel and the lens unit to provide display images having no incongruity for visual recognition by users is desired. Appropriate designing of arrangement for the display panel and the lens unit may contribute to improvement of this positional accuracy, but the achievable level of accuracy is limited.

One of objects of the present disclosure is to provide an image processing system, an image processing method, and a program that provide display images having no incongruity for visual recognition by users.

An image processing system proposed in the present disclosure is directed to an image processing system for generating a display image that is displayed on a display panel provided on a head-mounted display attached to a head of a user and that is enlarged, by a lens unit provided in correspondence with the display panel, to be visually recognized. The image processing system includes inclination correction means that corrects image data input to the display panel, on the basis of an inclination correction value associated with the display image in a three-dimensional space, and image generation means that generates the display image according to the image data corrected on the basis of the inclination correction value.

### BRIEF DESCRIPTION OF THE DRAWINGS

FIG. 1A is a perspective view illustrating an HMD viewed from the left front according to the present embodiment.

FIG. 1B is a left side view illustrating the HMD viewed from the left according to the present embodiment.

FIG. 2 is a diagram schematically illustrating configurations of display panels and an optical system according to the present embodiment.

FIG. 3 is a plan diagram illustrating the display panels viewed from the front according to the present embodiment.

FIG. 4 is a diagram illustrating an example of display images displayed on the respective display panels.

FIG. 5 is a diagram illustrating an example of a hardware configuration of an image processing system according to the present embodiment.

FIG. 6 is a functional block diagram illustrating an example of functions achieved by the image processing system according to the present embodiment.

FIG. 7 is a functional block diagram illustrating an example of functions achieved by the image processing system according to the present embodiment.

FIG. 8 is a flowchart illustrating an example of correction value acquisition control performed by the image processing system according to the present embodiment.

FIG. 9 is a flowchart illustrating an example of display control performed by the image processing system according to the present embodiment.

### DETAILED DESCRIPTION

Hereinafter, an embodiment according to the present disclosure (hereinafter referred to as the present embodiment) will be described with reference to the drawings. In the following description, a head-mounted display 1 will be referred to as an “HMD 1.” It is further assumed in the following description that directions represented by X1 and X2 in the figure are a rightward direction and a leftward direction, respectively, that directions represented by Y1 and Y2 in the figure are an upward direction and a downward direction, respectively, and that directions represented by Z1 and Z2 in the figure are a frontward direction and a rearward direction, respectively. Each of these directions is a direction viewed from a user wearing the HMD 1. Note that the left-right direction, the up-down direction, and the front-rear direction are not necessarily directions specified in a strict sense.

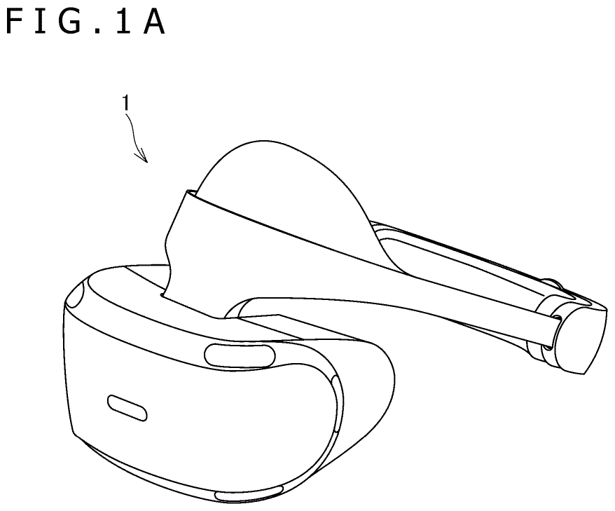

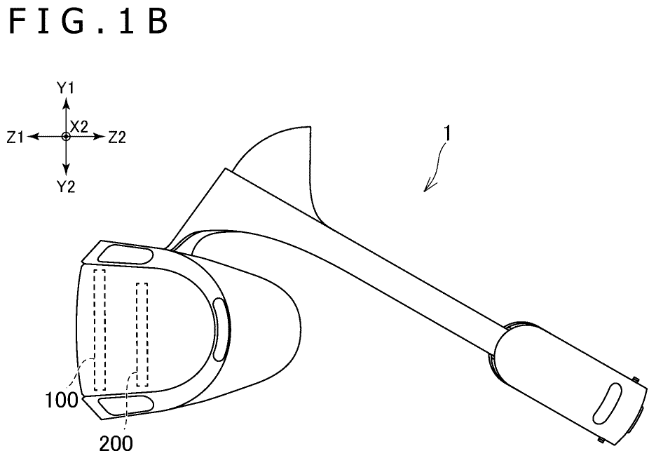

FIG. 1A is a perspective view illustrating the HMD viewed from the left front according to the present embodiment. FIG. 1B is a left side view illustrating the HMD viewed from the left according to the present embodiment. Note that a state of the HMD 1 being attached to the user will be referred to as a “use state” in the following description. In the use state, the front of the eyes of the user is covered by the HMD 1.

The HMD 1 preferably includes an attachment band covering the head of the user and a main body housing supported on a front part of the attachment band. A display unit 100 and components constituting an optical system, such as an ocular lens 200, are accommodated in the main body housing.

The display unit 100 includes display panels 10 described below. The display panels 10 preferably display three-dimensional images. For example, the display panels 10 are preferably constituted by liquid crystal displays or organic electroluminescence display devices, but are not specifically limited to these examples of types.

The HMD 1 is not limited to the HMD illustrated in FIGS. 1A and 1B only by way of example. The HMD 1 may be of any type as long as at least a display panel that is attached to the head of the user and that displays images is provided. The shapes and the like of the attachment band and the main body housing are not limited to those illustrated in the figure. Moreover, the display unit 100 and the ocular lens 200 are only schematically illustrated in FIG. 1B, and the respective shapes and sizes are not limited to those illustrated in the figure.

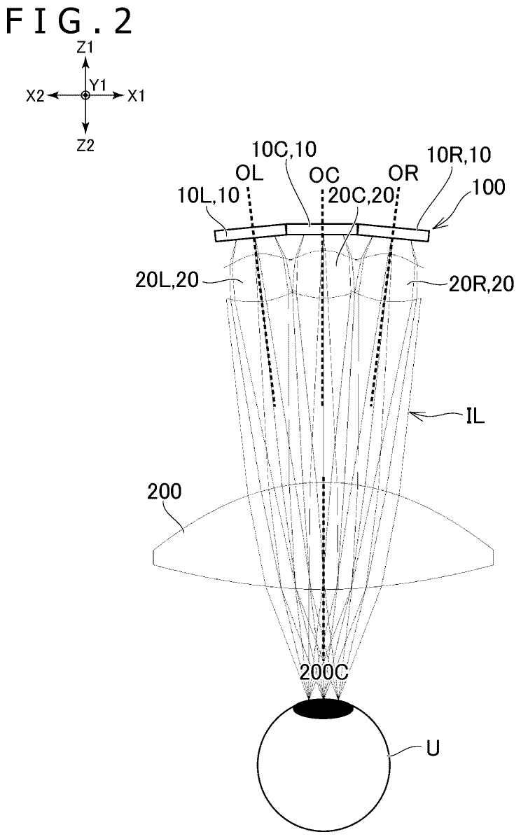

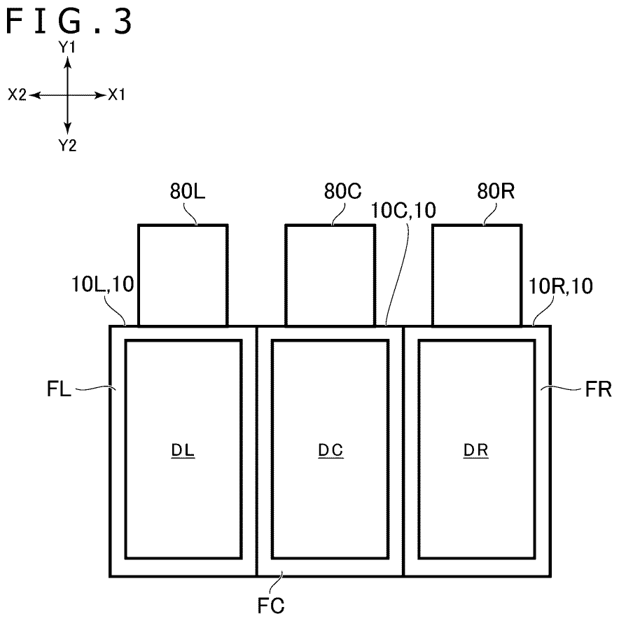

Details of configurations of the display panels and an optical system adopted in the present embodiment will subsequently be described with reference to FIGS. 2 and 3. FIG. 2 is a diagram schematically illustrating the configurations of the display panels and the optical system according to the present embodiment. FIG. 3 is a plan diagram illustrating the display panels viewed from the front according to the present embodiment. FIG. 2 illustrates the display panel and the optical system provided on either the right-eye side or the left-eye side of a user U. However, the configuration illustrated in FIG. 2 is preferably provided on both the right-eye side and the left-eye side. Note that the lens to be employed is not limited to a compound eye lens and may be a single eye lens.

The ocular lens 200 constitutes a part of the optical system of the HMD 1. The ocular lens 200 is a convex lens located in front of the right eye or the left eye of the user U in the use state and configured to collect image light IL emitted from each of the display panels 10 toward the eyeball of the user U. The ocular lens 200 has a function of enlarging images displayed on the display panels 10 and providing the enlarged images as images visually recognized by the user. Note that the ocular lens 200 may include two or more lenses. In addition, the ocular lens 200 may be a Fresnel lens or a liquid crystal lens.

An optical axis 200C of the ocular lens 200 is indicated by a broken line in FIG. 2. The optical axis herein refers to a virtual axis that passes through the center of the lens and that is perpendicular to the surface of the lens.

The display unit 100 includes a plurality of the display panels 10, a plurality of lens units 20 provided for the plurality of display panels 10 with one-to-one correspondence, and a support housing (not illustrated) for supporting the display panels 10 and the lens units 20.

According to the example discussed in the present embodiment, the plurality of display panels 10 include a front panel 10C, a right panel 10R, and a left panel 10L. For example, the front panel 10C, the right panel 10R, and the left panel 10L are each preferably constituted by a micro organic light emitting diode (OLED) of 0.49 inches or smaller. Three micro OLEDs of 0.49 inches (2K) arranged in a line can constitute a micro OLED of 1.5 inches (6K) in appearance. The cost for use of three 0.49-inch micro OLEDs is approximately one tenth of the cost for use of a 1.5-inch micro OLED.

In addition, according to the example discussed in the present embodiment, the plurality of lens units 20 include a front lens unit 20C, a right lens unit 20R, and a left lens unit 20L. These lens units 20 constitute the optical system in cooperation with the ocular lens 200. The lens units 20 are disposed before the display panels 10 in a state not in contact with the display panels 10. It is preferable that the distances between the lens units 20 and the display panels 10 be appropriately set to secure desired focal lengths. Note that the distance between a central portion of the right lens unit 20R and a central portion of the right panel 10R may be longer than the distance between a central portion of the front lens unit 20C and a central portion of the front panel 10C. Similarly, the distance between a central portion of the left lens unit 20L and a central portion of the left panel 10L may be longer than the distance between the central portion of the front lens unit 20C and the central portion of the front panel 10C. This configuration improves aberrations. Note that the central portion of the right lens unit 20R is a portion that faces the right panel 10R and that corresponds to a region where an optical axis OR passes while the central portion of the right panel 10R is a portion that faces the right lens unit 20R and that is located at the center in the up-down direction and the left-right direction. Similarly, the central portion of the left lens unit 20L is a portion that faces the left panel 10L and that corresponds to a region where an optical axis OL passes, while the central portion of the left panel 10L is a portion that faces the left lens unit 20L and that is located at the center in the up-down direction and the left-right direction.

Note that each of the front panel 10C, the right panel 10R, and the left panel 10L in the present embodiment will simply be referred to as the “display panel 10” in cases where no distinction is needed between these panels. Similarly, each of the front lens unit 20C, the right lens unit 20R, and the left lens unit 20L will simply be referred to as the “lens unit 20” in cases where no distinction is needed between these lens units.

As illustrated in FIG. 3, the front panel 10C includes a display region DC and a frame region FC surrounding the display region DC. The display region DC is a region including a plurality of unit pixels, and corresponds to a region for displaying images. The frame region FC is a region displaying no images.

As illustrated in FIG. 2, the front panel 10C is provided in front of the ocular lens 200. Specifically, the front panel 10C is provided on an extension line of the optical axis 200C of the ocular lens 200.

As illustrated in FIG. 3, the right panel 10R includes a display region DR and a frame region FR surrounding the display region DR. The display region DR is a region including a plurality of pixels, and corresponds to a region for displaying images. The frame region FR is a region displaying no images.

The right panel 10R is provided adjacent to the right side of the front panel 10C. Accordingly, the left part of the frame region FR of the right panel 10R and the right part of the frame region FC of the front panel 10C are provided adjacent to each other. The right panel 10R is not located on an extension line of the optical axis 200C of the ocular lens 200. The right panel 10R is provided on the right side with respect to the optical axis 200C, and faces the ocular lens 200.

Moreover, as illustrated in FIG. 2, the right panel 10R is disposed such that the display surface of the display region DR is inclined to the display surface of the display region DC to bring the right part of the right panel 10R closer to the ocular lens 200. Specifically, the display surface of the display region DR of the right panel 10R is inclined to the display surface of the display region DC of the front panel 10C by 6.5 degrees. However, the inclination is not limited to this specific inclination. The display surface of the display region DR of the right panel 10R preferably has inclination in a range of 6 to 7 degrees to the display surface of the display region DC of the front panel 10C.

As illustrated in FIG. 3, the left panel 10L includes a display region DL and a frame region FL surrounding the display region DL. The display region DL is a region including a plurality of pixels, and corresponds to a region for displaying images. The frame region FL is a region displaying no images.

The left panel 10L is provided adjacent to the left side of the front panel 10C. Accordingly, the right part of the frame region FL of the left panel 10L and the left part of the frame region FC of the front panel 10C are provided adjacent to each other. The left panel 10L is not located on an extension line of the optical axis 200C of the ocular lens 200. The left panel 10L is provided on the left side with respect to the optical axis 200C, and faces the ocular lens 200.

Moreover, as illustrated in FIG. 2, the left panel 10L is disposed such that the display surface of the display region DL is inclined to the display surface of the display region DC to bring the left part of the left panel 10L closer to the ocular lens 200. Specifically, the display surface of the display region DL of the left panel 10L is inclined to the display surface of the display region DC of the front panel 10C by 6.5 degrees. However, the inclination is not limited to this specific inclination. The display surface of the display region DL of the left panel 10L preferably has inclination in a range of 6 to 7 degrees to the display surface of the display region DC of the front panel 10C.

Note that each of the display panels 10 may be a flexible panel having flexibility. For example, flexible panels constituting the left panel 10L and the right panel 10R may be bended.

The front lens unit 20C is provided in front of the ocular lens 200. Specifically, the front lens unit 20C is provided on an extension line of the optical axis 200C of the ocular lens 200. Accordingly, the front lens unit 20C faces the front panel 10C.

The front lens unit 20C is a convex lens which guides the image light IL emitted from the display region DC, toward the ocular lens 200, to provide the enlarged display region DC for visual recognition by the user. The front lens unit 20C is provided in such a position that the optical axis OC of the front lens unit 20C crosses the display surface of the front panel 10C at right angles. The front lens unit 20C preferably has approximately the same size as the size of the front panel 10C or a size sufficient for covering at least a half of the display surface of the front panel 10C.

The right lens unit 20R is provided adjacent to the right side of the front lens unit 20C. The right lens unit 20R is provided on the right side with respect to the optical axis 200C, and faces the ocular lens 200. The right lens unit 20R is not located on an extension line of the optical axis 200C of the ocular lens 200.

The right lens unit 20R is a convex lens which guides the image light IL emitted from the display region DR, toward the ocular lens 200, to provide the enlarged display region DR for visual recognition by the user. The right lens unit 20R is provided in such a position that the optical axis OR of the right lens unit 20R crosses the display surface of the right panel 10R at right angles. Accordingly, the optical axis OR is inclined to the optical axis OC. Specifically, the optical axis OR of the right lens unit 20R is inclined to the optical axis OC of the front lens unit 20C by 6.5 degrees. However, the inclination is not limited to this specific inclination. The optical axis OR of the right lens unit 20R preferably has inclination in a range of 6 to 7 degrees to the optical axis OC of the front lens unit 20C. The right lens unit 20R preferably has approximately the same size as the size of the right panel 10R or a size sufficient for covering at least a half of the display surface of the right panel 10R.

The left lens unit 20L is provided adjacent to the left side of the front lens unit 20C. The left lens unit 20L is provided on the left side with respect to the optical axis 200C, and faces the ocular lens 200. The left lens unit 20L is not located on an extension line of the optical axis 200C of the ocular lens 200.

The left lens unit 20L is a convex lens which guides the image light IL emitted from the display region DL, toward the ocular lens 200, to provide the enlarged display region DL for visual recognition by the user. The left lens unit 20L is provided in such a position that the optical axis OL of the left lens unit 20L crosses the display surface of the left panel 10L at right angles. Accordingly, the optical axis OL is inclined to the optical axis OC. Specifically, the optical axis OL of the left lens unit 20L is inclined to the optical axis OC of the front lens unit 20C by 6.5 degrees. However, the inclination is not limited to this specific inclination. The optical axis OL of the left lens unit 20L preferably has inclination in a range of 6 to 7 degrees to the optical axis OC of the front lens unit 20C. The left lens unit 20L preferably has approximately the same size as the size of the left panel 10L or a size sufficient for covering at least a half of the display surface of the left panel 10L.

While the lens units 20 employed in the example discussed in the present embodiment are aspheric lenses, the lens units 20 may be constituted by spherical lenses or freeform lenses in place of aspheric lenses. Moreover, while the front lens unit 20C, the right lens unit 20R, and the left lens unit 20L are integrally formed in the example discussed in the present embodiment as illustrated in FIG. 2, these units may be separated from each other instead of being integrally formed. This integrated configuration of the front lens unit 20C, the right lens unit 20R, and the left lens unit 20L can easily improve accuracy of relative positions of the respective lens units. Meanwhile, as for the configuration including the front lens unit 20C, the right lens unit 20R, and the left lens unit 20L separated from each other, reduction of mold costs and lowering of step management complication are achievable by forming lenses having the same curved surface shape for the front lens unit 20C, the right lens unit 20R, and the left lens unit 20L as illustrated in FIG. 2. However, the front lens unit 20C, the right lens unit 20R, and the left lens unit 20L may have different shapes.

As illustrated in FIG. 3, the respective display panels 10 preferably include flexible wiring substrates 80C, 80R, and 80L for supplying image signals (image data) to the display regions of the display panels 10, respectively. Note that each of the flexible wiring substrates 80C, 80R, and 80L may be a wiring substrate for supplying a power source.

The flexible wiring substrates 80C, 80R, and 80L preferably extend in the direction perpendicular to the direction where the display panels 10 are arranged in a line (the left-right direction in the present embodiment). FIG. 3 illustrates a state of the flexible wiring substrates being attached to upper parts of the respective display panels 10 and extending upward.

The HMD 1 according to the present embodiment can provide high resolution images at a wide angle of view for visual recognition by the user with use of low-cost small panels. Moreover, the arrangement of a plurality of the lens units 20 provided for a plurality of the display panels 10 with one-to-one correspondence as adopted herein can provide a series of images for visual recognition by the user even with use of the display panels 10 each having a frame region.

Further, use of a plurality of the small display panels for the HMD 1 can reduce costs in comparison with use of a single large-sized display panel. For example, for display panels commercially available, when the area of a display region is doubled, purchase costs may rise up to ten times higher or more in some cases.

In general, for an HMD requiring a wide field of view, a lens having a diameter and a thickness approximately equivalent to those of an ocular lens needs to be added to increase resolution of the ocular lens. In this case, the HMD enlarges in the front-rear direction. The present embodiment adopts the configuration which includes a plurality of the lens units 20 arranged in a line in the left-right direction in addition to the ocular lens 200. In this case, the focal length of the optical system can be shortened without increasing the thickness of the ocular lens 200 or increasing curvature of the lens surfaces. Accordingly, the HMD 1 provided herein can realize high resolution of display images to be visually recognized, without a necessity of enlargement in the front-rear direction (depth direction). In addition, no lens is preferably provided between the ocular lens 200 and the lens units 20 in the front-rear direction.

Moreover, imaging performance of the ocular lens 200 increases with nearness to the optical axis 200C of the ocular lens 200, and decreases on the outer edge side of the ocular lens 200. Accordingly, images on the outer edge side of the ocular lens 200 tend to be visually recognized as more blurred images than in the vicinity of the optical axis 200C. The present embodiment adopts such a configuration where the lens units 20 are disposed in correspondence with the respective display regions. Accordingly, visibility can be raised even in the region of the outer edge side of the ocular lens 200. Further, according to the present embodiment, the right panel 10R and the left panel 10L are inclined to the front panel 10C to come to positions close to the ocular lens 200 as described above. Accordingly, visibility can be raised even in the region of the outer edge side of the ocular lens 200.

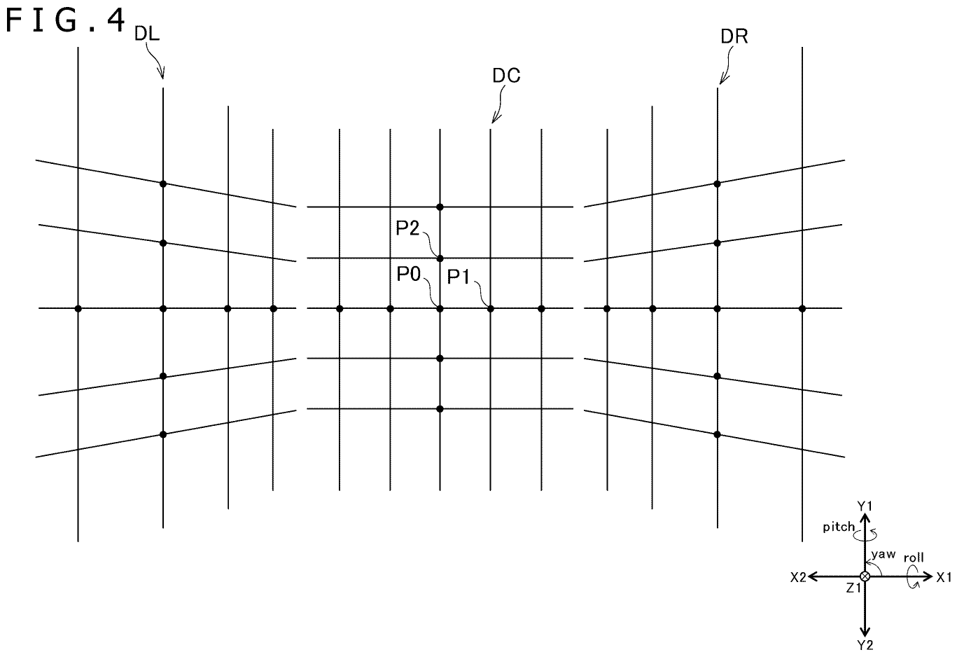

FIG. 4 is a diagram illustrating an example of display images displayed on the respective display panels. FIG. 4 illustrates a state of display which has a grid shape including a plurality of grid points as a display image on each of the display regions of the respective display panels. Note that FIG. 4 depicts a state of the display panels 10 viewed without use of the optical system including the lens units 20. Moreover, yaw, pitch, and roll in FIG. 4 each express an inclination direction of the display images in a three-dimensional space.

According to the present embodiment, the lens units 20 are provided for the respective display panels 10 with one-to-one correspondence. In this case, display images are distorted for visual recognition with use of the lens units 20. Accordingly, distortion correction using electronic means is required. Distortion correction is a correction for distorting an original image in an opposite direction according to distortion to provide an image having no distortion for visual recognition. Rectangular shapes are visually recognized as external shapes of the respective display images by distortion correction which displays images having opposite distortion in consideration of amounts of distortion corresponding to optical performance of the optical system. In this manner, the user is allowed to visually recognize a series of display images having no incongruity by using the configuration including a plurality of the display panels 10.

Note herein that in the HMD 1 according to the present embodiment, sufficient positional accuracy and posture accuracy of the display panels 10 and the lens units 20 is desired. For example, in a case where the display panels 10 are each disposed with inclination in a rotation direction (yaw in FIG. 4) around a rotation center located on a virtual axis extending in a direction perpendicular to the display surface of the corresponding display panel 10, display images visually recognized by the user are inclined images. In this case, defects may be produced on seams of the display images displayed on the respective display panels.

Moreover, in the configuration providing a series of display images for visual recognition by the user with use of a plurality of the display panels 10, particularly high accuracy of the positions and postures of the display panels 10 and the lens units 20 is desired. For example, in a case where the optical axis OC of the front lens unit 20C is inclined to the direction perpendicular to the display surface of the front panel 10C, a display image visually recognized via the front lens unit 20C is not distorted as desired. In this case, a consequent display image visually recognized after distortion correction does not have a desired shape. Accordingly, defects may be produced on seams between a display image formed by the front panel 10C and display images formed by the right panel 10R and the left panel 10L.

Moreover, in a case where the relative positions of the right panel 10R and the left panel 10L to the position of the front panel 10C are not appropriately set, for example, defects may be produced on seams between a display image formed by the front panel 10C and display images formed by the right panel 10R and the left panel 10L.

Appropriate designing of arrangement for the display panels 10 and the lens units 20 in such a manner as to reduce defects on the seams of the display images may contribute to solution of these problems. However, the expected level of accuracy is limited.

Further, three-dimensional correction of inclination of display images is important for providing a plurality of display images as a series of images having no incongruity for visual recognition.

Accordingly, the present embodiment provides an image processing system S capable of providing images having no incongruity for visual recognition by the user by correcting inclination of display images even in the presence of design errors in positions and postures of the display panels 10 and the lens units 20.

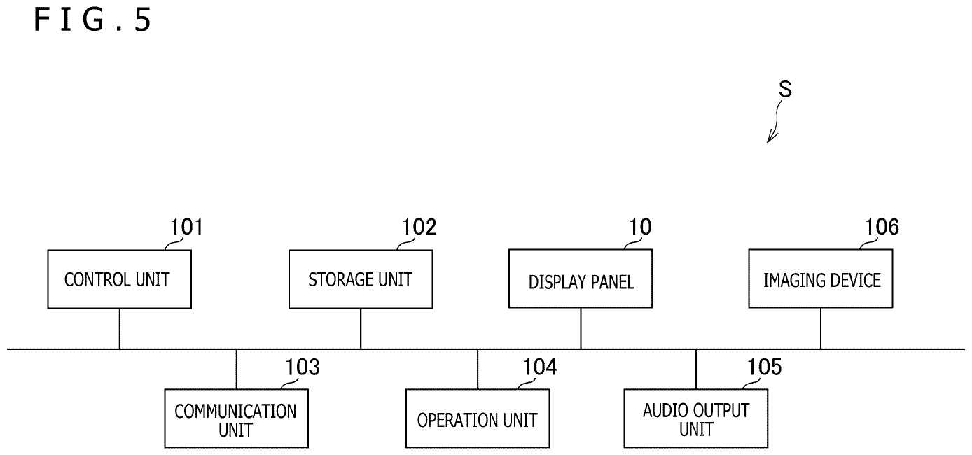

The image processing system S according to the present embodiment will be discussed with reference to FIG. 5. FIG. 5 is a diagram illustrating an example of a hardware configuration of the image processing system according to the present embodiment.

The image processing system S is a computer mounted on the HMD 1 or a computer mounted on a device different from the HMD 1. In addition, a part of the hardware configuration of the image processing system S may be mounted on the HMD 1, and another part of the configuration may be mounted on a different device. In other words, the image processing system S may be constituted by a plurality of computers. The plurality of computers are preferably connected with each other wirelessly or by wire.

As illustrated in FIG. 5, the image processing system S includes a control unit 101, a storage unit 102, a communication unit 103, an operation unit 104, an audio output unit 105, and an imaging device 106, in addition to the display panels 10.

The control unit 101 includes at least one processor. For example, the control unit 101 is preferably a program control device, such as a central processing unit (CPU), which operates under a program installed in the image processing system S. The control unit 101 further includes a graphics processing unit (GPU) which forms images on a frame buffer on the basis of graphics commands and data supplied from the CPU.

For example, the storage unit 102 includes a main storage such as a read only memory (ROM) and a random access memory (RAM) and an auxiliary storage such as a hard disk drive (HDD) and a solid state drive (SSD). The storage unit 102 stores programs and the like to be executed by the control unit 101. The storage unit 102 stores game programs (game software), for example, in addition to programs for implementing various functions of the image processing system S described below. Moreover, the storage unit 102 has a sufficient region for the frame buffer where images are formed by the GPU.

The communication unit 103 is a communication interface, such as an Ethernet (registered trademark) module and a wireless local area network (LAN) module, for example.

The operation unit 104 is a user interface such as a controller, and is configured to receive operation inputs from the user and output signals indicating contents of the inputs to the control unit 101.

The audio output unit 105 is a speaker or the like, for example, and is configured to output sounds indicated by audio data generated by the image processing system S.

The imaging device 106 is preferably constituted by a camera or the like, for example. The imaging device 106 is preferably configured to capture images of the display regions of the display panels 10 included in the HMD 1.

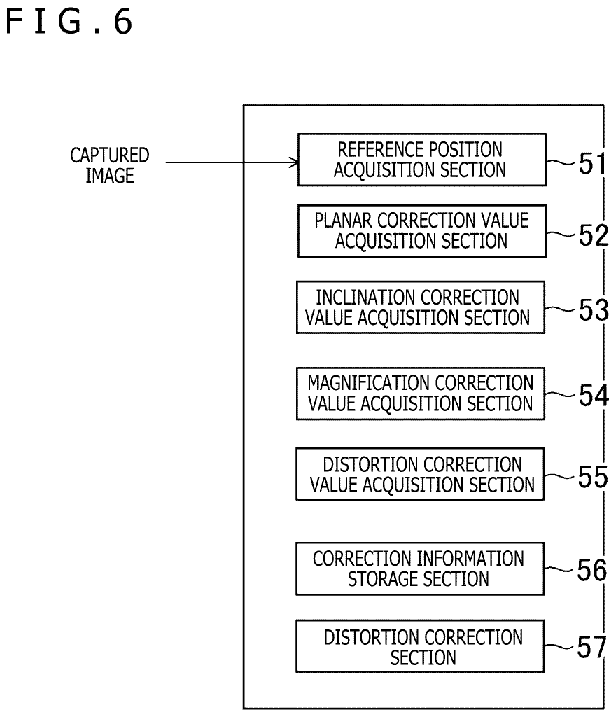

FIG. 6 is a functional block diagram illustrating an example of functions achieved by the image processing system according to the present embodiment. As illustrated in FIG. 6, the image processing system S implements a reference position acquisition section 51, a planar correction value acquisition section 52, an inclination correction value acquisition section 53, a magnification correction value acquisition section 54, a distortion correction value acquisition section 55, a correction information storage section 56, and a distortion correction section 57.

The reference position acquisition section 51, the planar correction value acquisition section 52, the inclination correction value acquisition section 53, the magnification correction value acquisition section 54, the distortion correction value acquisition section 55, and the distortion correction section 57 are chiefly implemented by the control unit 101. The correction information storage section 56 is chiefly implemented by the storage unit 102.

For example, the reference position acquisition section 51 acquires a reference position P0 indicating the center of the display region DL of the front panel 10C on the basis of a captured image obtained by the imaging device 106 capturing an image of the display region DL. In addition, the reference position acquisition section 51 preferably acquires reference positions P1 and P2 as well as the reference position P0 corresponding to an optical origin. The present embodiment will be discussed on an assumption that grid points indicated by P0, P1, and P2 in FIG. 4 are reference positions. However, these points are presented only by way of example. A plurality of points including three points not positioned on the same straight line can be defined as reference positions.

The planar correction value acquisition section 52 acquires planar correction values. The planar correction values correspond to information associated with positional correction for a display image in the up-down direction and the left-right direction. For example, the planar correction value acquisition section 52 preferably acquires, as planar correction values, deviations of reference positions acquired by the reference position acquisition section 51 from ideal reference positions obtained on the basis of design values beforehand.

The “ideal reference positions obtained on the basis of the design values beforehand” herein are positions (hereinafter referred to as given positions) obtained beforehand on the basis of at least arrangement of the display panels 10, the lens units 20, and the imaging device 106 and optical performance of the lens units 20.

The inclination correction value acquisition section 53 acquires inclination correction values. The inclination correction values correspond to information associated with inclination correction performed for display images in a three-dimensional space on the basis of inclination errors of at least either the display panels 10 or the lens units 20. Specifically, the inclination correction values are correction values associated with a rotation direction around a rotation center located on a virtual axis extending in a direction perpendicular to the display surface of each of the display panels 10 (yaw in FIG. 4), a rotation direction around a rotation center located on a virtual axis extending in the up-down direction of each of the display panels 10 (pitch in FIG. 4), and a rotation direction around a rotation center located on a virtual axis extending in the left-right direction of each of the display panels 10 (roll in FIG. 4).

For example, the inclination correction value acquisition section 53 acquires inclination correction values adjusted to minimize errors of reference positions acquired by the reference position acquisition section 51 from given positions obtained on the basis of design values beforehand.

The magnification correction value acquisition section 54 acquires magnification correction values. The magnification correction values correspond to information associated with correction of display magnification. Specifically, the magnification correction values represent information associated with size enlargement or reduction of a display image. For example, the magnification correction value acquisition section 54 acquires magnification correction values adjusted to minimize errors of reference positions acquired by the reference position acquisition section 51 from given positions obtained on the basis of design values beforehand.

The distortion correction value acquisition section 55 acquires distortion correction values. For example, the distortion correction value acquisition section 55 acquires distortion correction values adjusted to minimize errors of reference positions acquired by the reference position acquisition section 51 from given positions obtained on the basis of design values beforehand.

Note that the correction values discussed herein are preferably values set to minimize errors of reference positions with use of optimizing means such as a least-squares method, for example.

The correction information storage section 56 stores planar correction values acquired by the planar correction value acquisition section 52, inclination correction values acquired by the inclination correction value acquisition section 53, magnification correction values acquired by the magnification correction value acquisition section 54, and distortion correction value acquired by the distortion correction value acquisition section 55.

According to the present embodiment, planar correction values, inclination correction values, magnification correction values, and distortion correction values are preferably acquired for each of the front panel 10C, the right panel 10R, and the left panel 10L.

In addition, the display panels 10 use a common optical system according to the present embodiment. In other words, the front lens unit 20C, the right lens unit 20R, and the left lens unit 20L have common optical performance. Accordingly, correction values acquired in association with the front panel 10C are available for the right panel 10R and the left panel 10L with relative positions and relative inclinations in design of the right panel 10R and the left panel 10L to the front panel 10C taken into consideration. Specifically, for acquiring distortion correction values and magnification correction values associated with the right panel 10R, for example, optimal distortion correction values and magnification correction values of the right panel 10R are searchable on the basis of initial values (references), which are distortion correction values and magnification correction values associated with the front panel 10C and stored in the correction information storage section 56. In this manner, distortion correction values and magnification correction values associated with the right panel 10R can efficiently be acquired. The same is applicable to the left panel 10L.

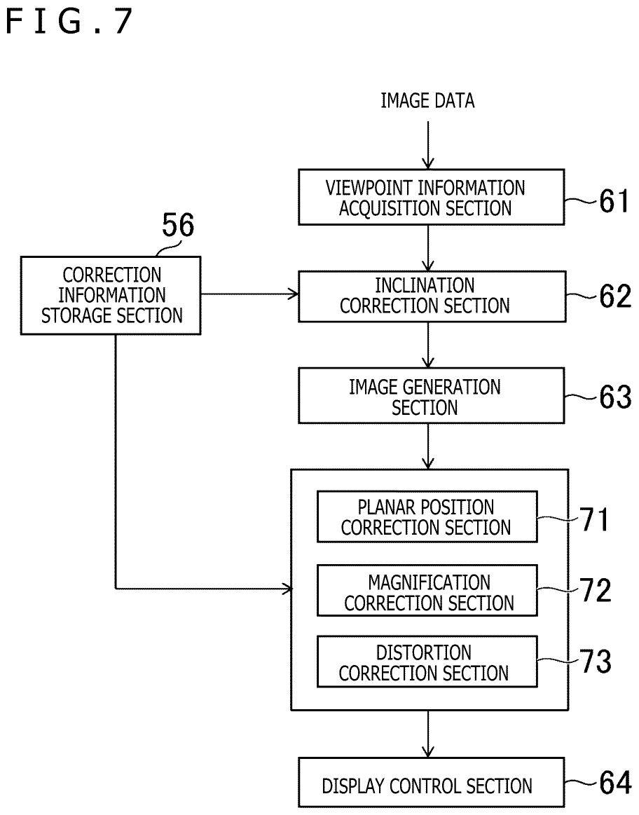

FIG. 7 is a function block diagram illustrating an example of functions achieved by the image processing system according to the present embodiment. As illustrated in FIG. 7, the image processing system S implements a viewpoint information acquisition section 61, an inclination correction section 62, an image generation section 63, a display control section 64, a planar position correction section 71, a magnification correction section 72, and a distortion correction section 73 in addition to the functions described with reference to FIG. 6. These functions are chiefly implemented by the control unit 101.

The correction information storage section 56 stores planar correction values, inclination correction values, magnification correction values, and distortion correction values associated with the display panels 10 and described with reference to FIG. 6.

Image data associated with videos, such as game screens, is input to the image processing system S. The image data includes viewpoint information corresponding to a posture of the HMD 1. The viewpoint information acquisition section 61 acquires viewpoint information corresponding to the posture of the HMD 1 on the basis of input image data.

The inclination correction section 62 corrects image data to such data for displaying images on the display panels 10 with inclinations in the yaw, pichi, and roll directions on the basis of inclination correction values stored in the correction information storage section 56.

The image generation section 63 renders images corrected by the inclination correction section 62, to generate images viewed from viewpoints corresponding to viewpoint information.

The planar position correction section 71 corrects planar positions of images generated by the image generation section 63, on the basis of planar correction values stored in the correction information storage section 56. Specifically, the planar position correction section 71 corrects image data to such data for displaying images shifted in X and Y directions from images generated by the image generation section 63.

The magnification correction section 72 corrects display magnification of images generated by the image generation section 63, on the basis of magnification correction values stored in the correction information storage section 56. Specifically, the magnification correction section 72 corrects image data to such data for displaying enlarged or reduced images of images generated by the image generation section 63, on the basis of magnification correction values stored in the correction information storage section 56.

The distortion correction section 73 corrects image data to such data for distorting images generated by the image generation section 63, on the basis of distortion correction values stored in the correction information storage section 56.

The display control section 64 causes the display panels 10 to display images corrected on the basis of position correction values, magnification correction values, and distortion correction values, as display images.

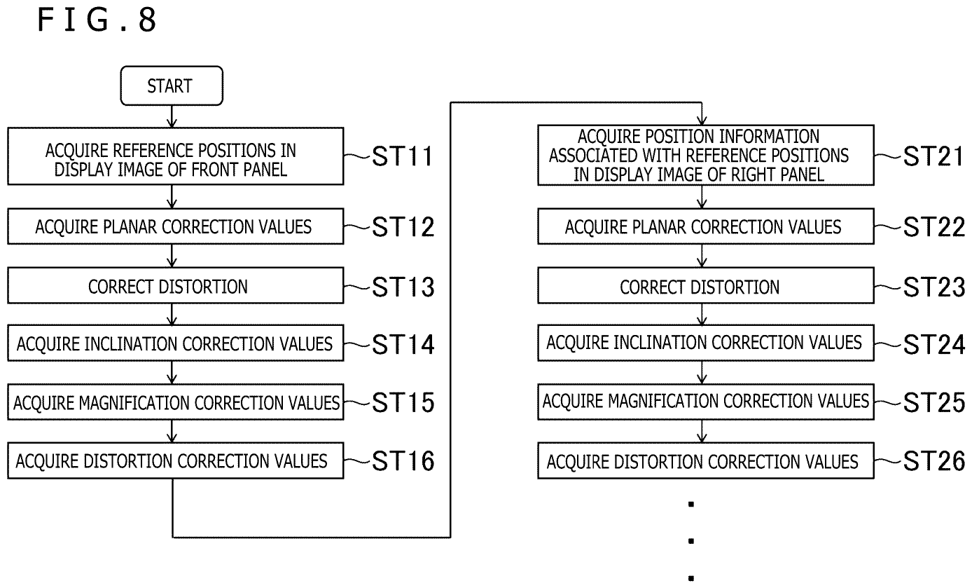

Correction value acquisition control performed by the image processing system S will subsequently be discussed with reference to FIG. 8. FIG. 8 is a flowchart illustrating an example of correction value acquisition control performed by the image processing system according to the present embodiment.

First, the reference position acquisition section 51 acquires reference positions on the basis of a captured image generated by a display image displayed on the front panel 10C being captured (ST11). Subsequently, the planar correction value acquisition section 52 acquires, as planar correction values, errors of the reference positions acquired by the reference position acquisition section 51 from given positions obtained from design values beforehand (ST12).

Subsequently, the distortion correction section 57 performs distortion correction on the basis of predetermined distortion correction values obtained from design values beforehand (ST13). By this step, the display image displayed on the front panel 10C becomes a substantially rectangular image. However, inclination correction and the like are not completed yet in this stage, and therefore, distortion and the like produced by design errors of the front panel 10C and the front lens unit 20C still remain.

Subsequently, inclination of the display image is corrected using predetermined inclination correction values set by the user. Thereafter, the inclination correction value acquisition section 53 repeatedly changes the inclination correction values within a predetermined range, and acquires inclination correction values which minimize errors from given positions obtained from design values beforehand (ST14).

Subsequently, the display image is enlarged or reduced using predetermined magnification correction values set by the user. Thereafter, the magnification correction value acquisition section 54 repeatedly changes the magnification correction values within a predetermined range, and acquires magnification correction values which minimize errors from given positions obtained from design values beforehand (ST15).

Subsequently, the distortion correction value acquisition section 55 changes the distortion correction values set in ST 13, to acquire distortion correction values which minimize errors from given reference positions obtained from design values beforehand (ST16).

Note that ST14 and ST15 may be repeated until optimal correction values are obtained. For example, after acquisition of inclination correction values in ST14 and then magnification correction values in ST15, ST14 may be performed again to carry out a process for searching for more optimal inclination values.

Further, correction values associated with a display image displayed on the right panel 10R are acquired. Processing from ST21 to ST21 corresponds to processing from ST11 to ST16 described above. Hereinafter, differences from ST11 to ST16 will chiefly be discussed.

In step ST23, distortion correction is preferably performed using distortion correction values associated with the front panel 10C and acquired in step ST16. Distortion correction close to ideal distortion correction is achievable for the right panel 10R as well with use of distortion correction values of the front panel 10C having the same optical performance as that of the right panel 10R.

In ST24, the inclination correction value acquisition section 53 repeatedly changes inclination correction values within a predetermined range, and acquires inclination correction values which minimize errors from given positions obtained from design values beforehand, as in ST14. In step ST24, inclination correction values associated with the front panel 10C and acquired in ST14 are preferably used as initial values during the changes of the inclination correction values within the predetermined range. Note that the inclination correction values used as initial values need to be changed with relative positions and relative inclinations in design of the right panel 10R to the front panel 10C taken into consideration. In this manner, optimal inclination correction values of the right panel 10R can efficiently be derived.

In ST25, the magnification correction value acquisition section 54 repeatedly changes magnification correction values within a predetermined range, and acquires magnification correction values which minimize errors from given positions obtained from design values beforehand, as in ST15. In step ST25, magnification correction values associated with the front panel 10C and acquired in ST15 are preferably used as initial values during the changes of the magnification correction values within the predetermined range. Note that the magnification correction values used as initial values need to be changed with relative positions and relative inclinations in design of the right panel 10R to the front panel 10C taken into consideration. In this manner, optimal magnification correction values of the right panel 10R can efficiently be derived.

In ST26, the distortion correction value acquisition section 55 changes distortion correction values set in ST23, to acquire distortion correction values which minimize errors from given positions obtained from design values beforehand.

Note that, while not illustrated in the figure nor explained in detail, processing similar to the processing from ST21 to ST26 can be carried out for the left panel 10L to acquire correction values. Note that relative positions and relative inclinations in design of the left panel 10L to the front panel 10C need to be considered in this case.

Moreover, correction values used for efficiently deriving correction values associated with the left panel 10L may be either correction values associated with the front panel 10C as with the case of the right panel 10R or the correction values of the right panel 10R. That is, the correction values to be used are not limited to the correction values associated with the front panel 10C, and it is sufficient if they are correction values associated with another display panel 10 and already acquired.

Note that, while discussed in the present embodiment has been the example which uses the three display panels 10, processing similar to the processing from ST21 to ST26 can be carried out to acquire correction values even in cases using the four or more display panels 10.

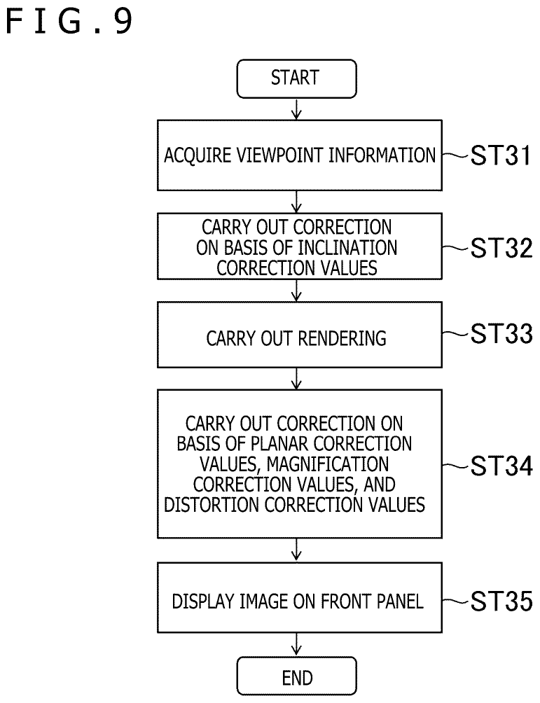

Display control performed by the image processing system S will subsequently be discussed with reference to FIG. 9. FIG. 9 is a flowchart illustrating an example of display control performed by the image processing system according to the present embodiment.

First, the viewpoint information acquisition section 61 acquires viewpoint information corresponding to a posture of the HMD 1 on the basis of image data input to the image processing system S (ST31). Subsequently, the inclination correction section 62 corrects the image data on the basis of inclination correction values (ST32). Moreover, the image generation section 63 carries out rendering on the basis of the image data corrected by the inclination correction, to generate an image viewed from a viewpoint corresponding to the viewpoint information (ST33). The inclination correction of image data carried out on the basis of inclination correction values before rendering in this manner can form an image appropriately expressing an object to be displayed according to viewpoint information.

Further, the image generated by the image generation section 63 is corrected on the basis of planar correction values, magnification correction values, and distortion correction values associated with the front panel 10C (ST34). Thereafter, the display control section 64 causes the front panel 10C to display an image corrected in step ST34, as a display image (ST35).

Note that display control similar to the display control of the front panel 10C discussed with reference to FIG. 9 can be performed for the right panel 10R and the left panel 10L. Specifically, the display control section 64 can cause the right panel 10R to display, as a display image, an image corrected on the basis of correction values associated with the right panel 10R and cause the left panel 10L to display, as a display image, an image corrected on the basis of respective correction values associated with the left panel 10L.

According to the present embodiment described above, display is achieved according to image data corrected on the basis of inclination correction values. In this manner, the user can visually recognize display images having no incongruity even in cases where the display panels 10 and the lens units 20 have design errors. Particularly, with use of the HMD 1 including a plurality of the display panels 10, the user can visually recognize seamless display images having no incongruity. Moreover, the image processing system S according to the present embodiment is suitable for such a configuration which includes a plurality of the display panels 10 having display surfaces inclined to each other and particularly high positional accuracy for the display panels 10 and the lens units 20 to allow visual recognition of seamless display images is desired.

Discussed in the embodiment has been the example which uses correction values associated with the front panel 10C for the other display panels 10 to efficiently acquire correction values associated with the other display panels 10. However, this acquisition may be achieved in different manners. Specifically, the correction values for the other display panels 10 may independently be acquired without using the correction values associated with the front panel 10C. Moreover, the method for acquiring the correction values is not limited to the method described with reference to FIG. 6. Specifically, any configurations may be adopted as long as images are generated using inclination correction values which have been acquired by any method together with other correction values and stored in the correction information storage section 56.

While discussed in the present embodiment has been the example which uses the display unit 100 including a plurality of the display panels 10, the present embodiment is applicable to the single display panel 10. Alternatively, the present embodiment is applicable to the four or more display panels 10. A larger number of seams are produced between display images as a larger number of the display panels 10 are used. Accordingly, the image processing system S described in the present embodiment is more suitable for these cases.

For example, the image processing system S can also be configured as follows.

(1)

An image processing system for generating a display image that is displayed on a display panel provided on a head-mounted display attached to a head of a user and that is enlarged, by a lens unit provided in correspondence with the display panel, to be visually recognized, the image processing system including:
inclination correction means that corrects image data input to the display panel, on the basis of an inclination correction value associated with the display image in a three-dimensional space; and
image generation means that generates the display image according to the image data corrected on the basis of the inclination correction value.
   (2)

The image processing system according to (1), in which
the head-mounted display includes a plurality of the display panels and a plurality of the lens units;
the plurality of display panels include at least a first display panel that is the display panel displaying a first display image and a second display panel that is the display panel adjacent to the first display panel and displaying a second display image,
the plurality of lens units include at least a first lens unit that is the lens unit provided in correspondence with the first display panel and a second lens unit that is the lens unit provided in correspondence with the second display panel,
the inclination correction means corrects first image data input to the first display panel, on the basis of a first inclination correction value associated with the first display image in the three-dimensional space,
the inclination correction means corrects second image data input to the second display panel, on the basis of a second inclination correction value associated with the second display image in the three-dimensional space,
the image generation means generates the first display image displayed on the first display panel according to the first image data corrected on the basis of the first inclination correction value, and
the image generation means generates the second display image that is displayed on the second display panel according to the second image data corrected on the basis of the second inclination correction value and is visually recognized by the user together with the first display image as a series of images.
   (3)

The image processing system according to (1) or (2), in which
the image data includes viewpoint information corresponding to a posture of the head-mounted display, and
the image generation means generates the display image viewed from a viewpoint corresponding to the viewpoint information by rendering based on the image data corrected by the inclination correction means.
   (4)

The image processing system according to any one of (1) to (3), in which the inclination correction value includes correction values associated with a rotation direction around a rotation center located on a virtual axis extending in a direction perpendicular to a display surface of the display panel, a rotation direction around a rotation center located on a virtual axis extending in an up-down direction of the display panel, and a rotation direction around a rotation center located on a virtual axis extending in a left-right direction of the display panel.

(5)

The image processing system according to (2), in which a display surface of the second display panel is inclined to a display surface of the first display panel.

(6)

The image processing system according to (2) or (5), further including:
reference position acquisition means that acquires a reference position on the basis of a captured image generated by imaging means capturing an image of the display panel; and
inclination correction value acquisition means that acquires the inclination correction value on the basis of an error of the reference position from a given position.
   (7)

The image processing system according to (6), in which
the first lens unit and the second lens unit have common optical performance, and
the inclination correction value acquisition means acquires the second inclination correction value calculated on the basis of the first inclination correction value as a reference.
   (8)

The image processing system according to (6) or (7), further including:
magnification correction means that corrects display magnification of the display image on the basis of a magnification correction value acquired according to an error of the reference position from a given position;
distortion correction means that corrects distortion of the display image on the basis of a distortion correction value acquired according to an error of the reference position from a given position; and
display control means that causes the display panel to display the display image corrected on the basis of the magnification correction value and the distortion correction value.

What is claimed is:

1. An image processing system comprising:
at least one processor; and
a memory storing instructions that, when executed by the at least one processor, cause the system to:
correct image data to a display panel of a head-mounted display, on a basis of an inclination correction value associated with a display image in a three-dimensional space; and
generate the display image according to the corrected image data.

2. The image processing system according to claim 1, wherein
the image data includes viewpoint information corresponding to a posture of the head-mounted display, and
wherein the instructions, when executed by the at least one processor, cause the system to generate the display image viewed from a viewpoint corresponding to the viewpoint information according to the corrected image data.

3. The image processing system according to claim 1, wherein the inclination correction value includes:
correction values associated with a rotation direction around a rotation center located on a virtual axis extending in a direction perpendicular to a display surface of the display panel;
a rotation direction around a rotation center located on a virtual axis extending in an up-down direction of the display panel; and
a rotation direction around a rotation center located on a virtual axis extending in a left-right direction of the display panel.

4. The image processing system according to claim 1, wherein the instructions, when executed by the at least one processor, cause the system to:
acquire a reference position on a basis of a captured image of the display panel; and
acquire the inclination correction value on a basis of an error of the reference position from a given position.

5. The image processing system according to claim 4, wherein the instructions, when executed by the at least one processor, cause the system to:
correct display magnification of the display image on a basis of a magnification correction value acquired according the error of the reference position from the given position;
correct distortion of the display image on a basis of a distortion correction value acquired according to the error of the reference position from the given position; and
cause the display panel to display the corrected display image on the basis of the magnification correction value and the distortion correction value.

6. The image processing system according to claim 1, wherein the head-mounted display includes:
a first display panel configured to display a first display image;
a second display panel adjacent to the first display panel, configured to display a second display image;
a first lens unit provided in correspondence with the first display panel; and
a second lens unit that provided in correspondence with the second display panel,
wherein the instructions, when executed by the at least one processor, cause the system to:
correct first image data to the first display panel, on a basis of a first inclination correction value associated with the first display image in the three-dimensional space;
correct second image data to the second display panel, on a basis of a second inclination correction value associated with the second display image in the three-dimensional space;
provide the first display image to the first display panel according to the corrected first image data; and
provide the second display image to the second display panel according to the corrected second image data, wherein the second display image and the first display image are adjacent images in a series of images.

7. The image processing system according to claim 6, wherein a display surface of the second display panel is inclined to a display surface of the first display panel.

8. The image processing system according to claim 6, wherein
the first lens unit and the second lens unit have common optical performance, and
wherein the instructions, when executed by the at least one processor, cause the system to acquire the second inclination correction value calculated on the basis of the first inclination correction value as a reference.

9. A method comprising:
correcting image data to a display panel of a head-mounted display, on a basis of an inclination correction value associated with a display image in a three-dimensional space; and
generating the display image according to the corrected image data on the basis of the inclination correction value.

10. The method of claim 9, wherein the image data includes viewpoint information corresponding to a posture of the head-mounted display, and
wherein the method further comprises generating the display image viewed from a viewpoint corresponding to the viewpoint information according to the corrected image data.

11. The method of claim 9, wherein the inclination correction value includes:
correction values associated with a rotation direction around a rotation center located on a virtual axis extending in a direction perpendicular to a display surface of the display panel;
a rotation direction around a rotation center located on a virtual axis extending in an up-down direction of the display panel; and
a rotation direction around a rotation center located on a virtual axis extending in a left-right direction of the display panel.

12. The method of claim 9, further comprising:
acquiring a reference position on a basis of a captured image of the display panel; and
acquiring the inclination correction value on a basis of an error of the reference position from a given position.

13. The method of claim 12, further comprising:
correcting display magnification of the display image on a basis of a magnification correction value acquired according the error of the reference position from the given position;
correcting distortion of the display image on a basis of a distortion correction value acquired according to the error of the reference position from the given position; and
causing the display panel to display the corrected display image on the basis of the magnification correction value and the distortion correction value.

14. The method of claim 9, wherein the head-mounted display includes:
a first display panel configured to display a first display image;
a second display panel adjacent to the first display panel, configured to display a second display image;
a first lens unit provided in correspondence with the first display panel; and
a second lens unit provided in correspondence with the second display panel,
wherein the method further comprises:
correcting first image data to the first display panel, on a basis of a first inclination correction value associated with the first display image in the three-dimensional space;
correcting second image data to the second display panel, on a basis of a second inclination correction value associated with the second display image in the three-dimensional space;
providing the first display image to the first display panel according to the corrected first image data; and
providing the second display image to the second display panel according to the corrected second image data, wherein the second display image and the first display image are adjacent images in a series of images.

15. The method of claim 14, wherein
the first lens unit and the second lens unit have common optical performance, and
wherein the method further comprises: acquiring the second inclination correction value calculated on the basis of the first inclination correction value as a reference.

16. A non-transitory computer-readable medium storing computer-readable instructions that, when executed by a computer, cause the computer to perform operations comprising:
correcting image data input to a display panel of a head-mounted display, on a basis of an inclination correction value associated with a display image in a three-dimensional space; and
generating the display image according to the image data corrected on the basis of the inclination correction value.

17. The non-transitory computer-readable medium of claim 16, wherein
the image data includes viewpoint information corresponding to a posture of the head-mounted display, and
wherein the operations further comprise generating the display image viewed from a viewpoint corresponding to the viewpoint information according to the corrected image data.

18. The non-transitory computer-readable medium of claim 16, wherein the inclination correction value includes:
correction values associated with a rotation direction around a rotation center located on a virtual axis extending in a direction perpendicular to a display surface of the display panel;
a rotation direction around a rotation center located on a virtual axis extending in an up-down direction of the display panel; and
a rotation direction around a rotation center located on a virtual axis extending in a left-right direction of the display panel.

19. The non-transitory computer-readable medium of claim 16, wherein the operations further comprise:
acquiring a reference position on a basis of a captured image of the display panel; and
acquiring the inclination correction value on a basis of an error of the reference position from a given position.

20. The non-transitory computer-readable medium of claim 19, wherein the operations further comprise:
correcting display magnification of the display image on a basis of a magnification correction value acquired according the error of the reference position from the given position;
correcting distortion of the display image on a basis of a distortion correction value acquired according to the error of the reference position from the given position; and
causing the display panel to display the corrected display image on the basis of the magnification correction value and the distortion correction value.
